(19) United States
(12) Patent Application Publication
(10) Pub. No.: US 2018/0116249 A1
(43) Pub. Date: May 3, 2018

(54) EDIBLE DOG CHEW WITH HOLLOW CYLINDRICAL TUBE AND METHOD FOR MAKING SUCH DOG CHEW

(71) Applicants: Xiang Chen, Shanghai (CN); Rongrong Chen, Shanghai (CN)

(72) Inventors: Xiang Chen, Shanghai (CN); Rongrong Chen, Shanghai (CN)

(21) Appl. No.: 15/799,313

(22) Filed: Oct. 31, 2017

Related U.S. Application Data
(60) Provisional application No. 62/415,892, filed on Nov. 1, 2016.

(51) Int. Cl. A23K 40/20; A23K 10/30; A23K 10/22; A23K 50/42

(52) U.S. Cl. CPC A23K 40/20; A23K 50/42; A23K 10/22; A23K 10/30

(57) ABSTRACT

An edible dog chew includes a hollow cylindrical tube of edible plant or animal material, the hollow cylindrical tube knotted at both ends. A method is also provided.

The present application claims the benefit of U.S. Provisional Application No. 62/415,892, filed Nov. 1, 2016, which is hereby incorporated by reference herein.

The present invention relates to dog chews, and more particularly to edible dog chews.

### BACKGROUND

Rawhide or rawhide free dog chew bones are made with sheets as semi-finished products before the workers make it to the final shape. The workers typically make the sheets first and roll the sheets by hands and then tie it into shapes such as bone shape.

U.S. Pat. No. 3,107,651 discloses an edible toy ball with a tube or core.

U.S. Pat. No. 9,226,516, hereby incorporated by reference herein, discloses an edible pet chew with a gluten free outer layer and an inner layer, the inner and outer layers being laminated, and then rolled into a cylindrical form and knotted at both ends to form a dog chew that resembles a bone.

### SUMMARY OF THE INVENTION

Such knotted dog chews as presented in U.S. Pat. No. 9,226,516 have the advantage over simply rolled dog chews that the knotted ends can provide a longer chew time or more chew material, and are seen as more appetizing to dogs, as they can often be held more easily by paws of the dog due to the knots.

However, the laminated, rolled and knotted chews as in U.S. Pat. No. 9,226,516 have the disadvantage that they typically require hand rolling and knotting, which entails significant labor costs. Simply molding edible material into shapes resembling bones also entails increased manufacturing costs. The molded shapes often can be quickly eaten by dogs.

Moreover, the extrusion of edible dog chew material that can be handled for easy shaping can be difficult. Solid cylindrical materials for example can be difficult to shape.

The present invention provides an edible dog chew comprising:

a hollow cylindrical tube of edible plant or animal material, the hollow cylindrical tube knotted at both ends.

The hollow tube of the present invention advantageously permits for easier handling and shaping, for example since the hollow tube can be compressed during knotting and is more flexible than a solid tube.

Additionally, the laminating step of two layered knotted dog chews can be eliminated, thereby significantly reducing, for example halving, the labor costs for knotted dog chews. A worker need not place two sheets on top of each other and roll the sheets prior to knotting.

Preferably, the edible plant or animal material includes over 50% of a combination of rice flour and corn starch, and most preferably more than 75% of such material. The present inventors have found that this advantageous amount of rice flour and corn starch also permits meat, such as chicken, beef, duck or seafood ingredients to be incorporated into the hallow cylindrical tube, to increase flavor without degrading the quality of the edible dog chew. The meat is preferably in the range of 5 to 15% in the pre-extruded mixture, i.e. by wet weight.

The tube may also contain a stripe of colored material including a coloring, forming for example half of the circumferential extent of the tube. The coloring for example may be green food coloring. The entire material may advantageously contain titanium dioxide to lighten the base material color and permit the food coloring to be more distinct. Such a dual color chew resembles more closely the laminated dog chews with which owners or dogs are familiar.

Xanthan gum in an amount of 4 to 6% by wet weight is also preferable, and aids in shaping and consistency.

The present invention also provides a method for forming an edible pet chew comprising:

extruding edible plant or animal material through an extruder mold to form a hollow cylindrical tube; and
drying the extruded edible plant or animal material.

The extruding of material into the hollow cylindrical tube permits advantageous shaping possibilities such as knotted ends, and thus the method can include knotting the hollow cylindrical tube at both ends, most preferably by hand.

### BRIEF DESCRIPTION OF THE DRAWINGS

The present invention will be described with respect to the following drawings in which:

FIG. 1 shows a preferred embodiment of an edible dog chew of the present invention with a hollow cylinder tube.

FIG. 2 shows schematically a possible mold for extruding the hollow cylindrical tube of edible material.

### DETAILED DESCRIPTION

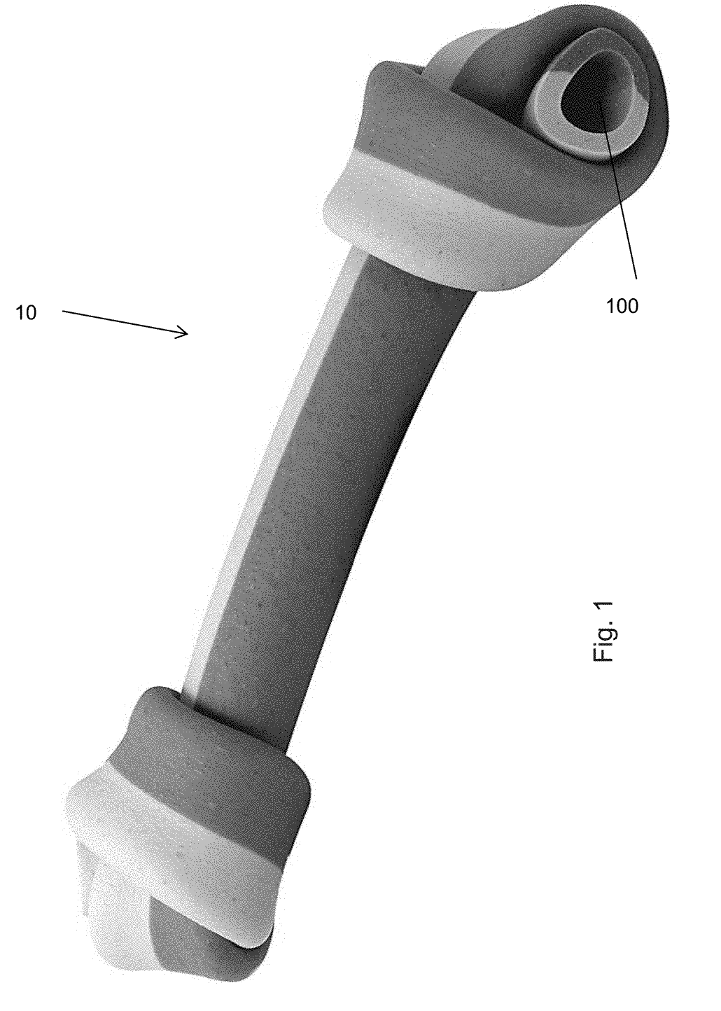

FIG. 1 shows a preferred embodiment of an edible dog chew 10 of the present invention with a hollow cylinder tube 100, preferable of two colors, such as white and green.

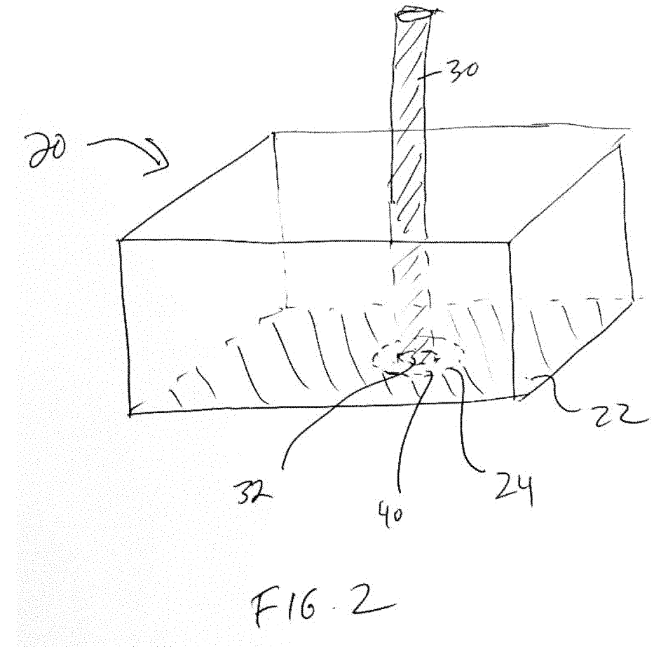

FIG. 2 shows a possible extrusion mold 20 holding wet edible material with a mold bottom 22 with a circular hole 24. A rod 30 and be held so that its bottom 32 fits in the middle of hole 24 with spacing, so that a “donut” or hollow ring 40 is formed. The wet edible material can be extruded through the donut to form the hollow cylindrical tube shape.

A thin partition can be placed in the container above the donut, so that for example a material on one side of the partition contains food coloring while the other side has a different color for example white or beige. In such a way a two-colored tube can be created.

The preferred embodiment can be manufactured as follows:

Step 1: Mixing of the edible plant or animal based material.

All of the ingredients are mixed in a mixer.

A preferred animal-free plant mixture includes rice flour at 46.8%, corn starch at 38.5%, xanthan gum at 5%, salt at 0.7%, glycerin at 8%, potassium sorbate at 0.5% and titanium dioxide at 0.5%. Flavorings can also be added.

A preferred edible mixture including meat includes rice flour at 45%, corn starch at 30%, chicken breast, beef, duck or seafood at 10. 3%, xanthan gum at 5%, salt at 0.7%, glycerin at 8%, potassium sorbate at 0.5% and titanium dioxide at 0.5%. Flavorings can also be added.

Step 2: Ripening the mixture.

The mixed raw ingredients can be “ripened” through a stainless steel extruder for example that shown in FIG. 2, at a temperature of 100-110 degrees Celsius. The extruding process can be repeated a few times by returning the material to the extruder before the mold, until the mixed raw materials are matured (cooked), malleable, and flexible with a certain strength. This returning and repeated extruding is particularly advantageous to create a proper malleable and flexible hollow tube. The extrusion at this point can take place simply though a hole without the rod 30 being present for example.

Step 3: Shaping into the hollow cylindrical tube

The matured (cooked) ingredients are placed into the heated extruder with the hollow cylinder mold, for example with rod 30, and the ingredients are extruded into a long hollow cylindrical continuous tube.

Step 4: Cutting

The continuous hollow cylindrical tube is cut the tube into different lengths as needed.

Step 5: Final shaping

The cut hollow cylindrical tubes are knotted by hand at the both ends of the cylindrical tube and to resemble a bone shape.

Step 6: Drying

The final shaped products are placed in an oven and dehydrated to reduce water content in the product. The drying may for example occur at 55 to 65 degrees Celsius for 24 to 32 hours.

Step 7: Sterilization.

The dried products can be sterilized, for example at 85 degrees Celsius for 30 minutes.

Step 8: Packaging

The sterilized dog chews can be packaged.

What is claimed is:

1. An edible dog chew comprising:
a hollow cylindrical tube of edible plant or animal material, the hollow cylindrical tube knotted at both ends.

2. The edible dog chew as recited in claim 1 wherein the edible plant or animal material includes over 50% by weight of a combination of rice flour and corn starch.

3. The edible dog chew as recited in claim 2 wherein the edible plant or animal material includes over 75% by weight of a combination of rice flour and corn starch.

4. The edible dog chew as recited in claim 1 wherein the edible plat or animal material includes animal material in the range of 5 to 15% by weight.

5. The edible dog chew as recited in claim 4 wherein the animal material includes fresh meat or seafood.

6. The edible dog chew as recited in claim 1 wherein the hollow cylindrical tube includes food coloring in a stripe of colored material.

7. The edible dog chew as recited in claim 1 wherein the edible plant or animal material includes xantham gum in an amount of 4 to 6% by weight.

8. A method for forming an edible pet chew comprising:
extruding edible plant or animal material through an extruder mold to form a hollow cylindrical tube; and
drying the extruded edible plant or animal material.

9. The method as recited in claim 8 further comprising knotting the hollow cylindrical tube at both ends.

10. The method as recited in claim 9 wherein the knotting is performed manually.

11. The method as recited in claim 8 further comprising mixing the edible plant or animal material and then ripening the edible plant or animal material by preliminary extruding before the extruding step.
